(19) United States
(12) Patent Application Publication
(10) Pub. No.: US 2022/0182763 A1
(43) Pub. Date: Jun. 9, 2022

(54) Diaphragm for Waterproof Microspeaker and Microspeaker Having the Same

(71) Applicant: EM-TECH Co., Ltd., Gyeongsangnam-do (KR)

(72) Inventors: Ki Hyun Nam, Gyeongsangnam-do (KR); Dong Woo Seok, Gyeongsangnam-do (KR); Gang Tae Kim, Gyeongsangnam-do (KR); Hyun Woo Jeong, Busan (KR); Jung Soo Lee, Gyeongsangnam-do (KR)

(21) Appl. No.: 17/540,295

(22) Filed: Dec. 2, 2021

(30) Foreign Application Priority Data
Dec. 4, 2020 (KR) 10-2020-0168409

(51) Int. Cl. H04R 7/04; H04R 31/00; H04R 9/06

(52) U.S. Cl. CPC H04R 7/04; H04R 31/003; H04R 2499/11; H04R 2307/025; H04R 9/06

(57) ABSTRACT

A high water pressure microspeaker is provided. A diaphragm of the waterproof microspeaker includes a side wall portion having a predetermined height and forming an outer portion, a center portion positioned on an inner side of a dome portion, and a silicone injection-molded portion including a dome portion protruding upward or downward along an inner circumference of the side wall portion and a waterproofing portion protruding upward or outward from the side wall portion, wherein the side wall portion and the center portion are formed of plastic, and the center portion and the side wall portion are integrally manufactured with the silicon injection-mold portion by double-shot injection-molding.

### TECHNICAL FIELD

The present disclosure relates to a high water pressure waterproof microspeaker.

### BACKGROUND

Mobile devices are equipped with a microspeaker to reproduce a notification sound or content sound for users. In order to maximize the convenience of mobile devices, the number of mobile devices having a water-resistance function has increased, and accordingly, it is necessary for a microspeaker itself installed in mobile devices to have a water-resistance function.

FIG. 1 is a view illustrating a waterproof microspeaker according to a related art, having a structure disclosed in Korean Patent Registration No. 10-1889315. A vibrating membrane body includes a rigid top 11, a silicone rubber membrane 12, and a plastic support 13 coupled to an edge of the silicone rubber membrane 12. The silicone rubber membrane 12 includes a planar coupling portion 12a positioned at a central position, a connection portion 12b positioned at an edge and injection-coupled to the plastic support 13 positioned at an edge, and a bent ring portion 12c positioned between the coupling portion 12a and the connection portion 12b. A protrusion or the bent ring portion 12c recessed inward may be provided at an outer position of the top 11 on the silicone rubber membrane 12, an interval between the outer edge of the top 11 and an inner edge of the bent ring portion 12c may range from about 002 mm to 02 mm, and an adhesive is applied to a gap between the top 11 and the bent ring portion 12c.

FIG. 2 is a view illustrating another waterproof microspeaker according to the related art. In the waterproof microspeaker, a magnetic circuit including a yoke 21, a center magnet 22, a side magnet 23, a center top plate 24, and a side top plate 25 is installed in a frame 10. A voice coil 30 is installed in an air gap between the center magnet 22 and the side magnet 23, and when a current is applied to the voice coil 30, the voice coil 30 vibrates up and down by mutual electromagnetic force with the magnetic circuit. An upper end of the voice coil 30 is attached to a lower surface of the side diaphragm 41 and the center diaphragm 50 to vibrate the center diaphragm 50 and the side diaphragm 41.

In order to seal between an inner wall of a device A on which the microspeaker is mounted and the microspeaker, the side diaphragm 41 has a waterproof structure.

The side diaphragm 41 is attached to a support 42, and a protruding waterproof ring 43 is installed outside the support 42. An adhesive having adhesive force by heat and pressure is applied to the side diaphragm 41 and the support. After the side diaphragm 41 is seated on the support 42 during an assembly process, the support 42 and the side diaphragm 41 may be attached to each other by applying heat and pressure.

The waterproof ring 43 is formed of liquid silicone rubber by injection molding or formed by a cured in place gasket (CIPG) method.

According to the related art, since a shape of the diaphragm (silicone rubber membrane) is formed and a bond is applied to the frame or diaphragm to attach it, a waterproof defect rate is affected by the amount of applied bond, an application position, and a pressure at the time of attachment. In addition, since an acoustic component is assembled using a waterproof tape during assembling with an electronic device, the waterproofing defect rate is affected by the amount of compression and foreign matter management of the waterproof tape.

### SUMMARY

An aspect of the present disclosure provides a waterproofing diaphragm capable of improving a waterproofing function with fewer coupling portions between components requiring waterproofing.

In an aspect, a diaphragm of a waterproof microspeaker includes: a side wall portion having a predetermined height and forming an outer portion; a center portion positioned on an inner side of a dome portion; and a silicone injection-molded portion including a dome portion protruding upward or downward along an inner circumference of the side wall portion and a waterproofing portion protruding upward or outward from the side wall portion, wherein the side wall portion and the center portion are formed of plastic, and the center portion and the side wall portion are integrally manufactured with the silicon injection-mold portion by double-shot injection-molding.

As another embodiment of the present disclosure, the silicone injection-molded portion may extend inward to completely cover an upper surface of the center portion.

Also, as another example of the present disclosure, the center portion may have a protrusion or a recess on a surface thereof in contact with the silicon injection-molded portion.

Also, as another example of the present disclosure, the center portion may protrude along an outer periphery and a protrusion portion thereof is thicker than other portions.

Also, as another example of the present disclosure, the side wall portion may have an uneven shape.

As another example of the present disclosure, the side wall portion may have an exposed portion not covered with the silicon injection-molded portion and may be exposed through the silicon injection-molded portion.

Also, as another example of the present disclosure, a thickness of the dome portion adjacent to the side wall portion may be greater than a thickness of the dome portion adjacent to the center portion.

In another aspect, a waterproof microspeaker includes: a frame; a magnetic circuit installed in the frame; a voice coil vibrating by mutual electromagnetic force with the magnetic circuit; and the diaphragm described above.

In another example of the present disclosure, the side wall portion may be coupled to an upper portion of the frame.

In another aspect, a waterproof microspeaker includes: a frame; a magnetic circuit installed in the frame; a voice coil vibrating by mutual electromagnetic force with the magnetic circuit; a diaphragm in which a side wall portion may have an exposed portion not covered with the silicon injection-molded portion and may be exposed through the silicon injection-molded portion; and a protector installed in an upper portion of the diaphragm, wherein the exposed portion of the side wall portion and the protector are heat-fused.

According to the waterproof diaphragm provided in the present disclosure, since the diaphragm, the support body, and the waterproof ring are integrally formed, the number of coupling portions between the components requiring waterproofing is reduced, thereby improving a waterproofing function.

In addition, the waterproof diaphragm provided in the present disclosure is injection-molded with liquid silicone rubber, is deformed by elasticity, and is in close contact with a device to increase watertightness.

### BRIEF DESCRIPTION OF THE DRAWINGS

FIG. 1 is a view illustrating a waterproof microspeaker according to the related art;

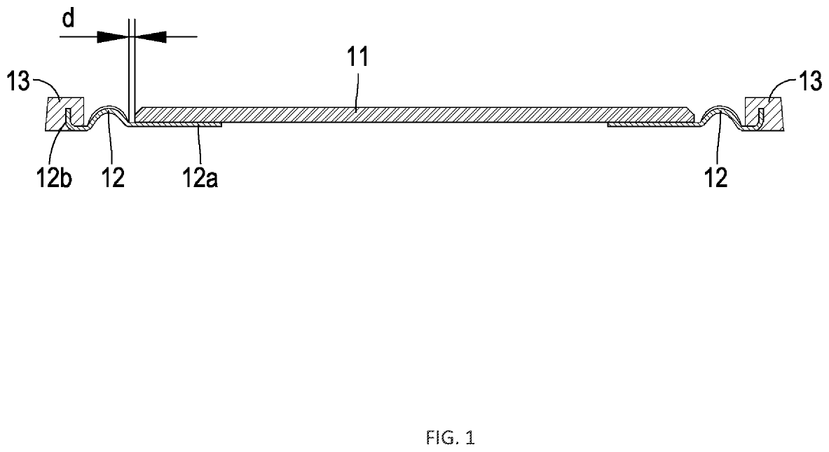

FIG. 2 is a view illustrating another waterproof microspeaker according to the related art;

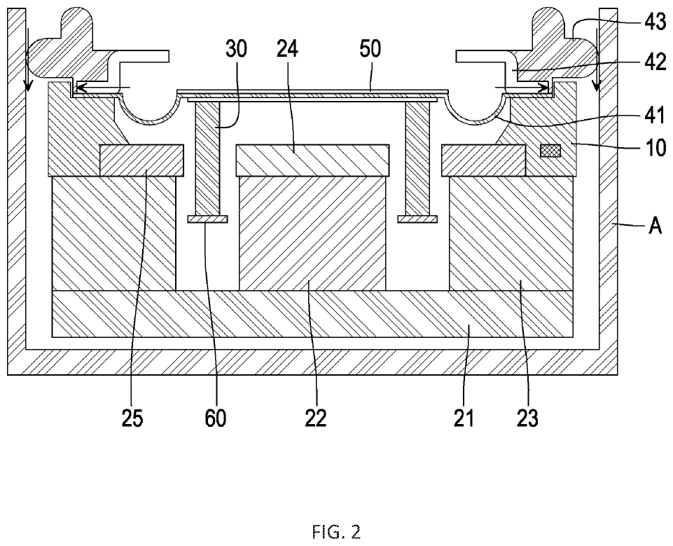

FIG. 3 is a view illustrating a diaphragm of a waterproof microspeaker according to a first embodiment of the present disclosure;

FIG. 4 is a view illustrating a diaphragm of a waterproof microspeaker according to a second embodiment of the present disclosure;

FIG. 5 is a view illustrating a diaphragm of a waterproof microspeaker according to a third embodiment of the present disclosure;

FIG. 6 is a cross-sectional view illustrating a diaphragm of a waterproof microspeaker according to a fourth embodiment of the present disclosure;

FIG. 7 is a perspective view illustrating a diaphragm of a waterproof microspeaker according to the fourth embodiment of the present disclosure;

FIG. 8 is a perspective view illustrating a diaphragm of a waterproof microspeaker according to a fifth embodiment of the present disclosure;

FIG. 9 is a view illustrating a state in which a protector is coupled to a diaphragm of a waterproof microspeaker according to the fifth embodiment;

FIG. 10 is a view illustrating a center portion of a diaphragm of a waterproof microspeaker according to a sixth embodiment of the present disclosure;

FIG. 11 is an enlarged view of a dome portion of a diaphragm of a waterproof microspeaker according to the first embodiment of the present disclosure;

FIG. 12 is a graph comparing sound pressures for each frequency between a dome portion having a uniform thickness and a dome portion having different thicknesses (varied thicknesses) in a diaphragm of a waterproof microspeaker according to the present disclosure;

FIG. 13 is a view illustrating a diaphragm of a waterproof microspeaker according to a seventh embodiment of the present disclosure;

FIG. 14 is a view illustrating a waterproof microspeaker having a diaphragm according to the first embodiment of the present disclosure;

FIG. 15 is a view illustrating a waterproof microspeaker having a diaphragm according to the seventh embodiment of the present disclosure; and

FIG. 16 is a view illustrating a coupling state of a frame and an internal terminal of a waterproof microspeaker according to the seventh embodiment of the present disclosure.

### DETAILED DESCRIPTION

Hereinafter, the present disclosure is described in detail with reference to the drawings.

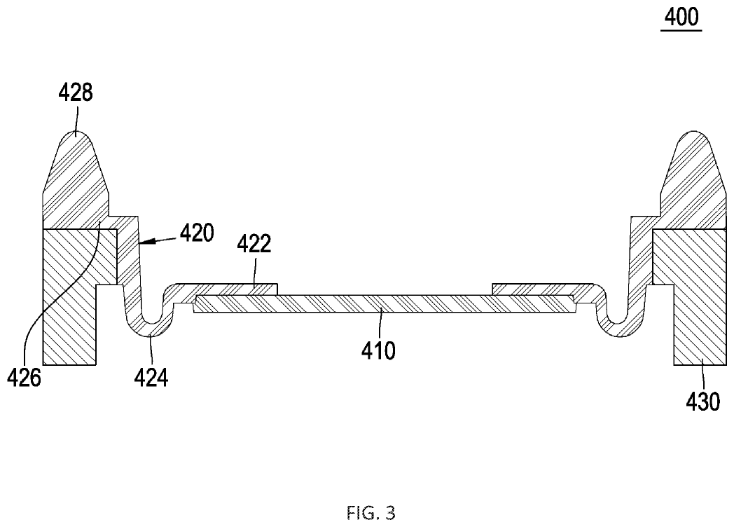

FIG. 3 is a view illustrating a diaphragm of the waterproof microspeaker according to a first embodiment of the present disclosure.

A diaphragm 400 of a waterproof microspeaker according to the first embodiment of the present disclosure includes a center portion 410 formed of a plastic injection-molded material having a predetermined rigidity, a side wall portion 430 having a certain height and forming an outer portion of the diaphragm 400, and a silicone injection-molded portion 420 integrally manufactured by double-shot injection molding with the center portion 410 and the side wall portion 430.

The silicone injection-molded portion 420 includes an inner peripheral portion 422 attached to the center portion 410, an outer peripheral portion 426 attached to the side wall portion 430, and a dome portion 424 protruding upward or downward between the inner peripheral portion 422 and the outer peripheral portion 426. In addition, the outer peripheral portion 426 is provided with a waterproof ring portion 428 protruding upward or outward to increase watertightness. In the first embodiment of the present disclosure, a configuration in which the dome portion 424 protrudes downward is adopted for the purpose of slimming of the microspeaker. In addition, the waterproof ring portion 428 has a shape protruding upward.

The silicone injection-molded portion 420 is injection-molded with liquid silicone rubber. The side wall portion 430 and the center portion 410 are integrated by double-shot injection. First, the center portion 410 and the side wall portion 430 are injection-molded with a plastic material, and then the silicone injection-molded portion 420 is formed of liquid silicone rubber, so that the diaphragm 400 is integrally manufactured.

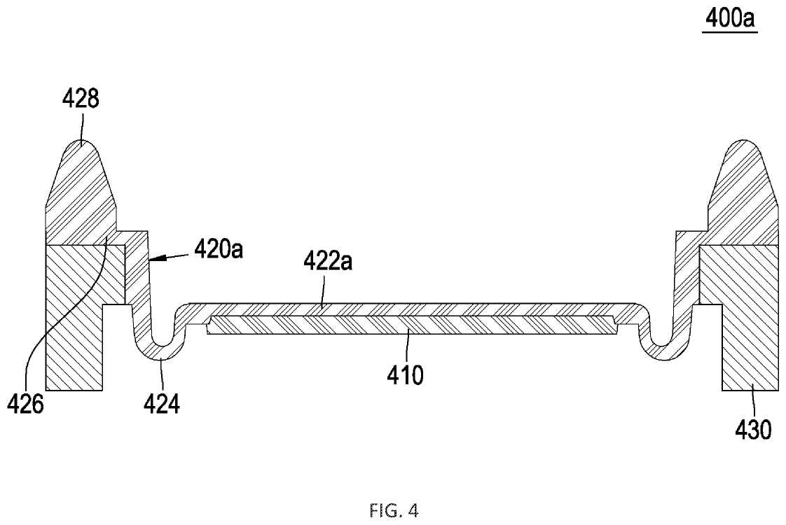

FIG. 4 is a view illustrating a diaphragm of a waterproof microspeaker according to a second embodiment of the present disclosure.

A diaphragm 400a of a waterproof microspeaker according to the second embodiment of the present disclosure has the same shape, function, and coupling relationship of components as those of the components of the first embodiment, except for a shape of the inner peripheral portion 422. In the first embodiment, the inner peripheral portion 422 covers only a portion along an outer circumference of the center portion 410, but in the second embodiment of the present disclosure, an inner peripheral portion 422a covers the entire upper surface of the center portion 410. In this case, a weight of a vibrating portion of the diaphragm 400a may slightly increase, but there is an advantage in that an adhesive strength between the center portion 410 and the silicone injection-molded portion 420a may increase.

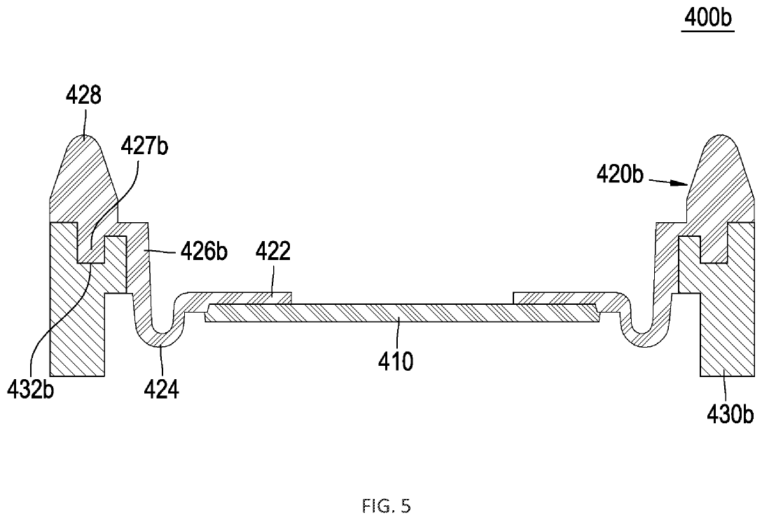

FIG. 5 is a diagram illustrating a diaphragm of a waterproof microspeaker according to a third embodiment of the present disclosure. A diaphragm 400b of a waterproof microspeaker according to the third embodiment of the present disclosure is the same as the first embodiment, except for a coupling portion of a silicone injection-molded portion 420b and a side wall portion 430b.

In the third embodiment of the present disclosure, a bonding area between the side wall portion 430b and the silicone injection-molded portion 420b is increased in order to improve an adhesive strength of the silicone injection-molded portion 420b, which does not have high adhesive strength in the case of heterogeneous bonding. The side wall portion 430b has an uneven portion 432b such as a protrusion or a recess on an upper surface thereof and has a coupling shape 427b corresponding to the uneven portion 432b during double-shot injection molding of the silicone injection-molded portion 420b.

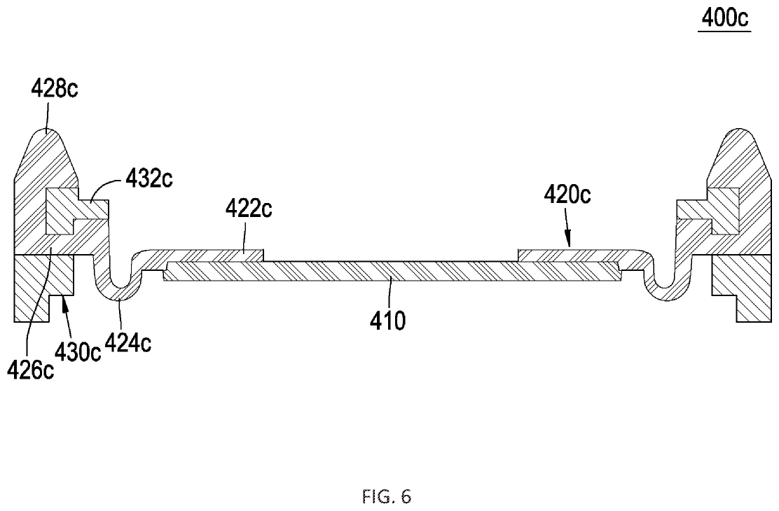

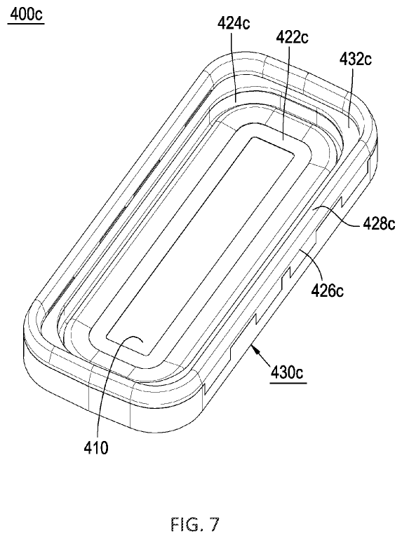

FIG. 6 is a cross-sectional view illustrating a diaphragm of a waterproof microspeaker according to a fourth embodiment of the present disclosure, and FIG. 7 is a perspective view illustrating a diaphragm of a waterproof microspeaker according to the fourth embodiment of the present disclosure. The diaphragm of the waterproof microspeaker according to the fourth embodiment of the present disclosure is the same as that of the first embodiment except for the shapes of a silicone injection-molded portion 420c and a side wall portion 430c.

In the fourth embodiment of the present disclosure, a portion of the side wall portion 430c has an exposed portion 432c exposed upward from an outer periphery portion 426c of the silicon injection-molded portion 420c. The exposed portion 432c of the side wall portion 430c is not covered by the silicone injection-molded portion 420c and is exposed through the silicone injection-molded portion 420c. When the exposed portion 432c is coupled with other components of the microspeaker such as a protector (not shown) on an upper portion of a diaphragm 400c, the exposed portion 432c may be pressed and heated so as to be easily heat-fused with a component such as a projector (not shown). In the case of the side wall portion 430c formed as a plastic injection-molded material, bonding properties with other materials is better than that of the silicone injection-molded portion 420c, and thus, when the exposed portion 432c is formed, assembly of a microspeaker is improved.

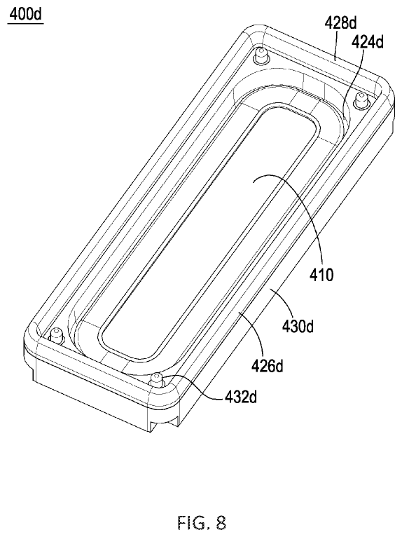

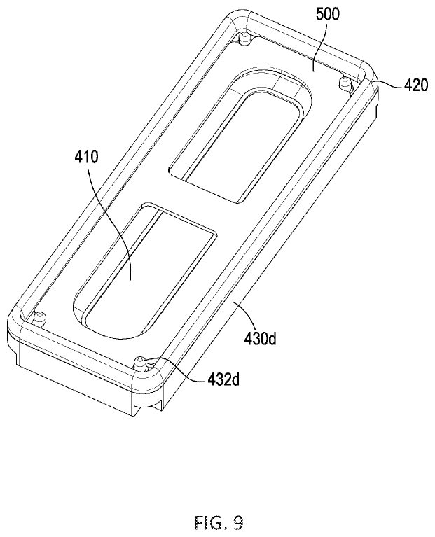

FIG. 8 is a perspective view illustrating a diaphragm of a waterproof microspeaker according to a fifth embodiment of the present disclosure, and FIG. 9 is a view illustrating a state in which a protector is coupled to a diaphragm of a waterproof microspeaker according to the fifth embodiment.

A diaphragm 400d according to the fifth embodiment of the present disclosure is the same as that of the fourth embodiment in that the diaphragm 400d has an exposed portion 432d in which a portion of a side wall portion 430d is exposed, but unlike the fourth embodiment in which the exposed portion is continuously formed to have a ring shape along an inner circumference of the waterproof ring portion, in the fifth embodiment, the exposed portion 432d is provided as a protrusion and formed at four corner portions.

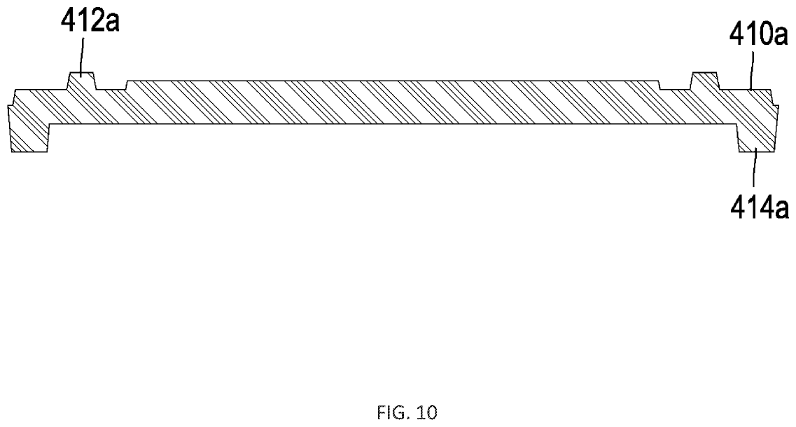

FIG. 10 is a view illustrating a center portion of a diaphragm of a waterproof microspeaker according to a sixth embodiment of the present disclosure. According to the sixth embodiment of the present disclosure, a center portion 410a of the diaphragm may have a protrusion 412a or a recess on a surface in contact with the silicone injection-molded portion to enhance adhesion with the silicone injection-molded portion. In this case, a plurality of protrusions 412a or recesses may be provided. Meanwhile, a portion of the center portion 410a protrudes upward or downward along the outer periphery, and the protrusion portion may include an edge portion 414a thicker than other portions. The edge portion 414a may not only increase rigidity of the center portion 410a but also serve to guide an installation position of a voice coil (not shown) during assembling of the microspeaker.

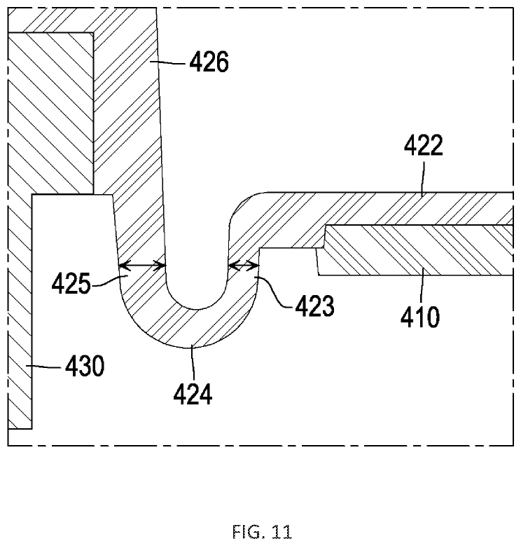

FIG. 11 is an enlarged view of a dome portion of a diaphragm of a waterproof microspeaker according to the first embodiment of the present disclosure.

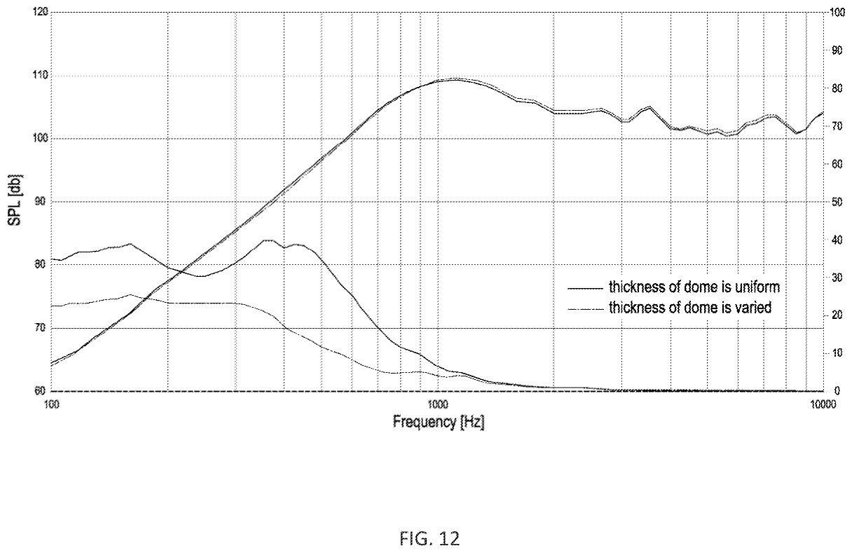

In the dome portion 424 of the silicone injection-molded portion, a thickness 425 of the dome portion 424 adjacent to the side wall portion 430 is greater than a thickness 423 of the dome portion 424 adjacent to the center portion 422. When the dome portion 424 includes the different thicknesses in this manner, the rigidity is high on the side of the side wall portion 430 with less movement, and the rigidity is low on the side of center portion 410 with a large amplitude. FIG. 12 is a graph comparing sound pressures for each frequency between a dome portion having a uniform thickness and a dome portion having different thicknesses in a diaphragm of a waterproof microspeaker according to the present disclosure. As can be seen from the graph, when the inner thickness of the dome portion 424 is small and the outer thickness large to make a difference in thickness, divided vibration may be improved during an operation of the microspeaker and total harmonic distortion (THD) is lowered.

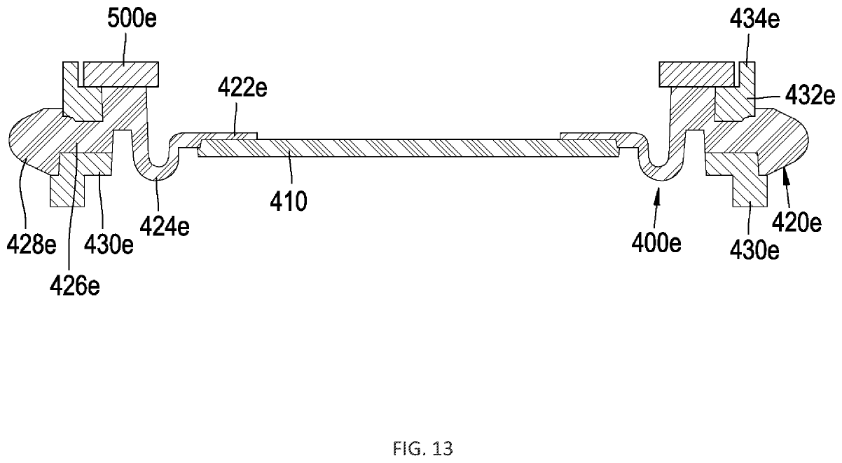

FIG. 13 is a view illustrating a diaphragm of a waterproof microspeaker according to a seventh embodiment of the present disclosure.

In a diaphragm 400e of a waterproof microspeaker according to the seventh embodiment of the present disclosure, a waterproof ring portion 428e of a silicone injection-molded portion 420e penetrates through a side wall portion 430e and protrudes in an outward direction, rather than an upward direction of the side wall portion 430e. That is, an outer peripheral portion 426e of the silicon injection-molded portion 420e penetrates through the side wall portion 430e. In addition, the side wall portion 430e has an exposed portion 432e exposed upward from the silicone injection-molded portion 420e on an upper portion thereof, and the exposed portion 432e has a protrusion portion 434e further protruding upward along the outer periphery. The protrusion 434e guides an installation position of a protector 500e coupled to the diaphragm 400e, and after the protector 500e is seated in the protrusion portion 434e of the diaphragm 400e the protrusion portion 434e is heat-fused to be fixedly coupled with the protector 500e.

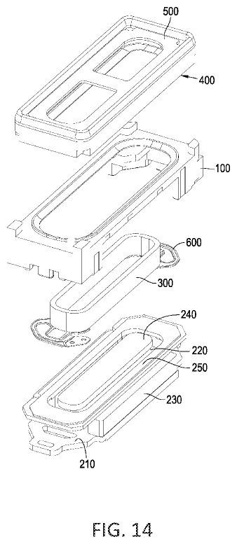

FIG. 14 is a diagram illustrating a microspeaker including a diaphragm of a waterproof microspeaker according to the first embodiment of the present disclosure.

In a waterproof microspeaker according to an embodiment of the present disclosure, a magnetic circuit including a yoke 210, a center magnet 220, a side magnet 230, a center top plate 240, and a side top plate 250 is installed in a frame 100. A voice coil 300 is installed in an air gap between the center magnet 220 and the side magnet 230, and when a current is applied to the voice coil 300, the voice coil 300 vibrates up and down by mutual electromagnetic force with the magnetic circuit. A conductor 600 or a flexible printed circuit board (FPCB) for transmitting an electrical signal to the voice coil 300 may be attached to a lower end of the voice coil 300 and may extend to one side of the frame 100 or may be drawn out of the frame 100. A protector 500 is installed inside the waterproof ring portion of the diaphragm 400.

The diaphragm 400 as described above is installed on an upper portion of the frame 100. The side wall portion of the diaphragm 400 formed of a plastic injection-molded material is coupled to the frame 100, thereby facilitating assembling of the microspeaker.

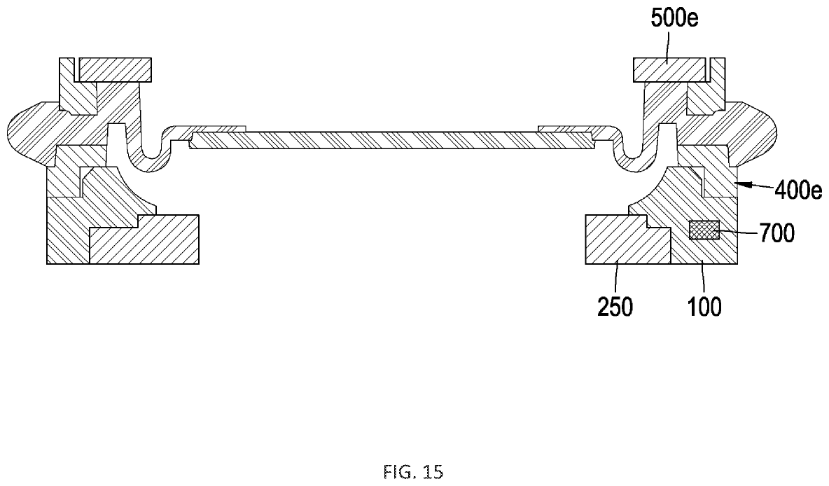

FIG. 15 is a diagram illustrating a waterproof microspeaker including a diaphragm according to a seventh embodiment of the present disclosure.

The side wall portion 430e of the diaphragm 400e of the waterproof microspeaker according to the seventh embodiment of the present disclosure is also installed on an upper surface of the frame 100. In addition, as described above, the protector 500e is coupled to upper surfaces of the side wall portion 430e and the silicone injection-molded portion 420e. Accordingly, even if pressure is applied from a counterpart on which the waterproof microspeaker is installed, that is, from an outer surface, deformation is prevented because a lower end of the side wall portion 430e is supported by the frame 100 and an upper end of the side wall portion 430e is supported by the protector 500e, and deformation occurs only in the silicon injection-molded portion 420e, specifically, only in the waterproof ring portion 428e of the silicon injection-molded portion 420e. In the waterproof ring portion 428e, a contact area with the counterpart and contact pressure may be improved in the process of deformation, and thus, watertightness is increased.

Meanwhile, the frame 100 includes the conductor 600 (see FIG. 14) for transmitting an electrical signal or an internal terminal 700 providing an electrical connection between an FPCB or an external power source.

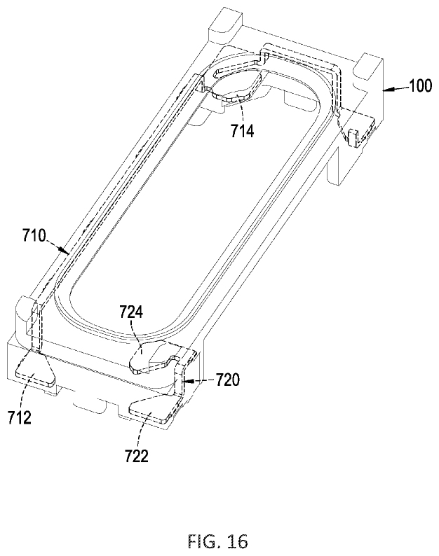

FIG. 16 is a view illustrating a coupling state of a frame and an internal terminal of a waterproof microspeaker according to the seventh embodiment of the present disclosure. Inner terminals 710 and 720 may be integrally molded with the frame 100 through insert-injection during injection molding of the frame 100. The inner terminals 710 and 720 may be formed of two terminals separated from each other to be insulated from each other. The inner terminals 710 and 720 have outer ends 712 and 722 exposed to the outside of the frame 100 and inner ends 714 and 724 exposed to the inside of the frame 100, respectively. An external signal line is soldered or electrically connected to the outer ends 712 and 722, and the conductor 600 (see FIG. 14) or an FPCB transmitting an electrical signal to a lead wire of the voice coil or the voice coil may be soldered or electrically connected to the inner ends 714 and 724.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A diaphragm of a waterproof microspeaker, the diaphragm comprising:
a side wall portion having a predetermined height and forming an outer portion;
a center portion positioned on an inner side of a dome portion; and
a silicone injection-molded portion including a dome portion protruding upward or downward along an inner circumference of the side wall portion and a waterproofing portion protruding upward or outward from the side wall portion,
wherein the side wall portion and the center portion are formed of plastic, and the center portion and the side wall portion are integrally manufactured with the silicon injection-mold portion by double-shot injection-molding.

2. The diaphragm of claim 1, wherein the silicone injection-molded portion extends inward to completely cover an upper surface of the center portion.

3. The diaphragm of claim 2, wherein the center portion has a protrusion or a recess on a surface thereof in contact with the silicon injection-molded portion.

4. The diaphragm of claim 1, wherein the center portion protrudes along an outer periphery and a protrusion portion thereof is thicker than other portions.

5. The diaphragm of claim 1, wherein the side wall portion has an uneven shape.

6. The diaphragm of claim 1, wherein the side wall portion has an exposed portion not covered with the silicon injection-molded portion.

7. The diaphragm of claim 6, wherein the exposed portion of the side wall portion is exposed through the silicon injection-molded portion.

8. The diaphragm of claim 1, wherein a thickness of the dome portion adjacent to the side wall portion is greater than a thickness of the dome portion adjacent to the center portion.

9. A waterproof microspeaker, comprising:
a frame;
a magnetic circuit installed in the frame;
a voice coil configured to vibrate by mutual electromagnetic force with the magnetic circuit; and
a diaphragm comprising a side wall portion having a predetermined height and forming an outer portion, a center portion positioned on an inner side of a dome portion, and a silicone injection-molded portion including a dome portion protruding upward or downward along an inner circumference of the side wall portion and a waterproofing portion protruding upward or outward from the side wall portion, wherein the side wall portion and the center portion are formed of plastic, and the center portion and the side wall portion are integrally manufactured with the silicon injection-mold portion by double-shot injection-molding.

10. The waterproof microspeaker of claim 9, wherein the side wall portion is coupled to an upper portion of the frame.

11. A waterproof microspeaker, comprising:
a frame;
a magnetic circuit installed in the frame;
a voice coil configured to vibrate by mutual electromagnetic force with the magnetic circuit;
a diaphragm comprising a side wall portion having a predetermined height and forming an outer portion, a center portion positioned on an inner side of a dome portion, and a silicone injection-molded portion including a dome portion protruding upward or downward along an inner circumference of the side wall portion and a waterproofing portion protruding upward or outward from the side wall portion, wherein the side wall portion and the center portion are formed of plastic, and the center portion and the side wall portion are integrally manufactured with the silicon injection-mold portion by double-shot injection-molding; and
a protector installed in an upper portion of the diaphragm,
wherein the side wall portion has an exposed portion not covered with the silicon injection-molded portion,
wherein the exposed portion of the side wall portion and the protector are heat-fused.
